(19) United States
(12) Patent Application Publication
(10) Pub. No.: US 2025/0167551 A1
(43) Pub. Date: May 22, 2025

(54) FREQUENCY STABILIZATION SYSTEM AND FREQUENCY STABILIZATION METHOD

(71) Applicant: TMEIC Corporation, Tokyo (JP)

(72) Inventor: Haiqing LI, Tokyo (JP)

(73) Assignee: TMEIC Corporation, Tokyo (JP)

(21) Appl. No.: 18/727,121

(22) PCT Filed: Nov. 7, 2022
(86) PCT No.: PCT/JP2022/041377

§ 371 Date: Feb. 11, 2025

(51) Int. Cl. H02J 3/24; H02J 3/32; H02J 3/38; H02J 7/00

(52) U.S. Cl. CPC H02J 3/241; H02J 3/32; H02J 3/38; H02J 7/00712; H02J 2300/24

(57) ABSTRACT

A frequency stabilization system according to an aspect includes: a power conversion unit configured to convert DC power into AC power and output the AC power to a power grid, the DC power being output by at least any of a photovoltaic panel and a storage battery; a bidirectional DC converter that is connected to the storage battery in series, the bidirectional DC converter being configured to control charging and discharging of the storage battery for the power conversion unit based on an active-power command value; a grid frequency detection unit configured to detect a grid frequency of AC power to be output to the power grid by the power conversion unit; a necessary-power calculation section configured to calculate power necessary for the power grid based on the detected grid frequency; a command value calculation section configured to calculate an active-power command value for the bidirectional DC converter based on the calculated necessary power; and an output control section configured to control a charging or discharging output of the storage battery to the power conversion unit by the bidirectional DC converter based on the calculated active-power command value.

### TECHNICAL FIELD

The present invention relates to a frequency stabilization system and a frequency stabilization method.

### BACKGROUND ART

For example, a grid-connected system that converts DC power generated by a photovoltaic panel (PV panel) into AC power by using a PCS (power conditioner: Power Conditioning System) and connects a power grid has been typically known to be configured to include a storage battery that is charged with the generated power.

The grid frequency of the power grid fluctuates under various conditions such as a fluctuation in the amount of power generated by the photovoltaic panel.

For example, in a case where a plurality of remote islands including pieces of power generation equipment that use renewable energy and power storage devices is connected to each other through power transmission lines to constitute a small-scale power grid, a frequency control method has been known that controls the grid frequency by taking into consideration a fluctuation in the amount of power generated from the renewable energy caused by the influence of natural conditions (see, for example, PTL 1).

In addition, an output control device has been publicly known that includes a conversion unit and an output unit (see, for example, PTL 2). In a case where it is possible to supply a power grid with power generated by a power generation device that generates power by using sunlight, the conversion unit converts the generated power into AC power having a frequency within a first range defined in advance. In a case where it is not possible to supply the power grid with the generated power, the conversion unit converts power accumulated in a storage battery into AC power having a frequency within a second range that is lower than or equal to the lower limit of the frequency within the first range. The output unit outputs the AC power whose frequency has been converted by the conversion unit to the power grid. The output control device controls the outputs of the power generated by the power generation device and the power discharged from the storage battery to the power grid.

### CITATION LIST

### Patent Literature

[PTL 1] JP 2016-178736 A
[PTL 2] JP 2022-025226 A

### SUMMARY OF THE INVENTION

### Problem to be Solved by the Invention

There is, however, a problem about failure to stabilize the grid frequency of a power grid in a case where a photovoltaic panel and a storage battery are connected in parallel to connect to the power grid on a DC side.

The present invention has been devised to solve the problem as described above. An object of the present invention is to provide a frequency stabilization system and a frequency stabilization method that each make it possible to convert DC power generated by a photovoltaic panel into AC power that is stabilized within a predetermined frequency range.

### Means for Solving the Problem

According to one aspect of the present invention, a frequency stabilization system including a photovoltaic panel and a storage battery that are connected in parallel to connect to a power grid, the frequency stabilization system comprising a power conversion unit configured to convert DC power into AC power and output the AC power to the power grid, the DC power being output by at least any of the photovoltaic panel and the storage battery; a bidirectional DC converter that is connected to the storage battery in series, the bidirectional DC converter being configured to control charging and discharging of the storage battery for the power conversion unit based on an active-power command value; a grid frequency detection unit configured to detect a grid frequency of AC power to be output to the power grid by the power conversion unit; a necessary-power calculation section configured to calculate power necessary for the power grid based on the grid frequency detected by the grid frequency detection unit; a command value calculation section configured to calculate an active-power command value for the bidirectional DC converter based on the necessary power calculated by the necessary-power calculation section; and an output control section configured to control a charging or discharging output of the storage battery to the power conversion unit by the bidirectional DC converter based on the active-power command value calculated by the command value calculation section.

Also, according to another aspect of the present invention, the frequency stabilization system, further comprising a frequency determination section configured to determine whether the grid frequency detected by the grid frequency detection unit is a frequency higher than a predetermined frequency range or a frequency lower than the frequency range, or is within the frequency range, wherein the command value calculation section calculates an active-power command value to bring power to be output to the power conversion unit by the photovoltaic panel closer to 0 and cause the bidirectional DC converter to charge and discharge the storage battery with as great power as the necessary power calculated by the necessary-power calculation section in a case where the frequency determination section determines that the grid frequency detected by the grid frequency detection unit is the frequency higher than the frequency range.

Also, according to another aspect of the present invention, the frequency stabilization system, wherein the command value calculation section calculates an active-power command value to bring the power to be output to the power conversion unit by the photovoltaic panel closer to the necessary power calculated by the necessary-power calculation section and cause the storage battery to discharge, to the power conversion unit, power enough to reach the necessary power calculated by the necessary-power calculation section in a case where the frequency determination section determines that the grid frequency detected by the grid frequency detection unit is the frequency lower than the frequency range.

Also, according to another aspect of the present invention, the frequency stabilization system, wherein the command value calculation section calculates an active-power command value to maximize the power to be output to the power conversion unit by the photovoltaic panel in a case where the frequency determination section determines that the grid frequency detected by the grid frequency detection unit is within the frequency range.

Also, according to another aspect of the present invention, a frequency stabilization method that controls a frequency stabilization system including a photovoltaic panel, a storage battery, a power conversion unit, and a bidirectional DC converter, the photovoltaic panel and the storage battery being connected in parallel to connect to a power grid, the power conversion unit being configured to convert DC power into AC power and output the AC power to the power grid, the DC power being output by at least any of the photovoltaic panel and the storage battery, the bidirectional DC converter being connected to the storage battery in series, the bidirectional DC converter being configured to control charging and discharging of the storage battery for the power conversion unit based on an active-power command value, the frequency stabilization method comprising: a grid frequency detection step of detecting a grid frequency of AC power to be output to the power grid by the power conversion unit; a necessary-power calculation step of calculating power necessary for the power grid based on the grid frequency detected in the grid frequency detection step; a command value calculation step of calculating an active-power command value for the bidirectional DC converter based on the necessary power calculated in the necessary-power calculation step; and an output control step of controlling a charging or discharging output of the storage battery to the power conversion unit by the bidirectional DC converter based on the active-power command value calculated in the command value calculation step.

Also, according to another aspect of the present invention, the frequency stabilization method, further comprising a frequency determination step of determining whether the grid frequency detected in the grid frequency detection step is a frequency higher than a predetermined frequency range or a frequency lower than the frequency range, or is within the frequency range, wherein an active-power command value is calculated in the command value calculation step to bring power to be output to the power conversion unit by the photovoltaic panel closer to 0 and cause the bidirectional DC converter to charge and discharge the storage battery with as great power as the necessary power calculated in the necessary-power calculation step in a case where it is determined in the frequency determination step that the grid frequency detected in the grid frequency detection step is the frequency higher than the frequency range.

Also, according to another aspect of the present invention, the frequency stabilization method, wherein an active-power command value is calculated in the command value calculation step to bring the power to be output to the power conversion unit by the photovoltaic panel closer to the necessary power calculated in the necessary-power calculation step and cause the storage battery to discharge, to the power conversion unit, power enough to reach the necessary power calculated in the necessary-power calculation step in a case where it is determined in the frequency determination step that the grid frequency detected in the grid frequency detection step is the frequency lower than the frequency range.

Also, according to another aspect of the present invention, the frequency stabilization method, wherein an active-power command value is calculated in the command value calculation step to maximize the power to be output to the power conversion unit by the photovoltaic panel in a case where it is determined in the frequency determination step that the grid frequency detected in the grid frequency detection step is within the frequency range.

### Advantageous Effects of the Invention

The present invention makes it possible to convert DC power generated by a photovoltaic panel into AC power that is stabilized within a predetermined frequency range.

### BRIEF DESCRIPTION OF DRAWINGS

FIG. 1 is a diagram illustrating a configuration example of a frequency stabilization system 1 according to an embodiment.

FIG. 2 is a functional block diagram exemplifying functions of the PCS 4.

FIG. 3 is a functional block diagram exemplifying functions of the bidirectional DC converter 5.

FIG. 4 is a graph showing an overview of the dfdP function.

FIG. 5 is a diagram showing an example of the operation of the frequency stabilization system when the system frequency is higher than a predetermined frequency range.

FIG. 6 is a diagram showing an example of the operation of the frequency stabilization system when the system frequency is lower than a predetermined frequency range.

### DESCRIPTION OF EMBODIMENT

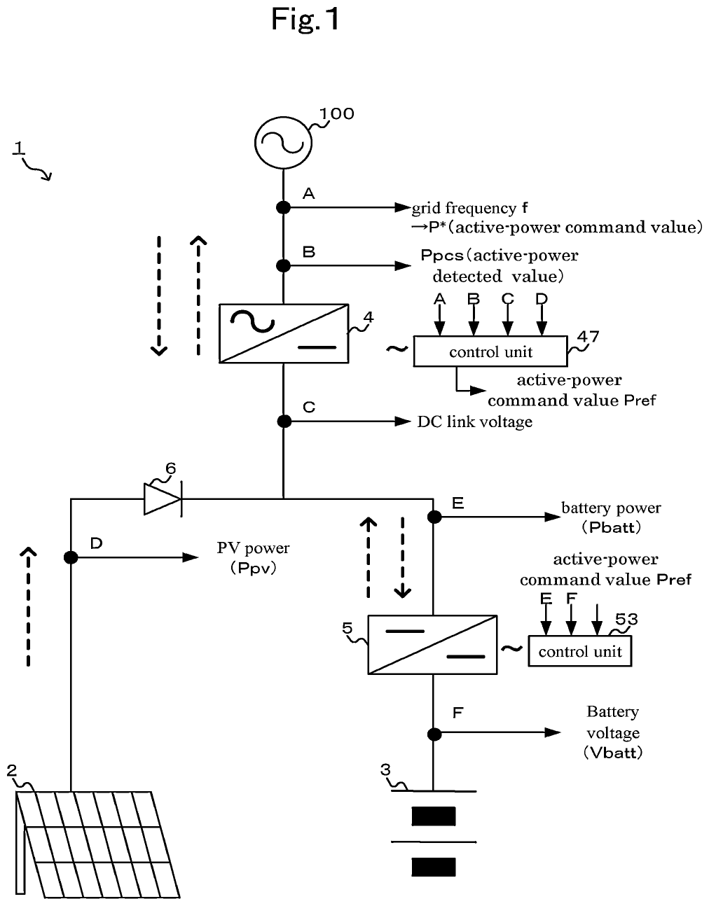

The following describes a frequency stabilization system according to an embodiment by using the drawings. FIG. 1 is a diagram illustrating a configuration example of a frequency stabilization system 1 according to an embodiment.

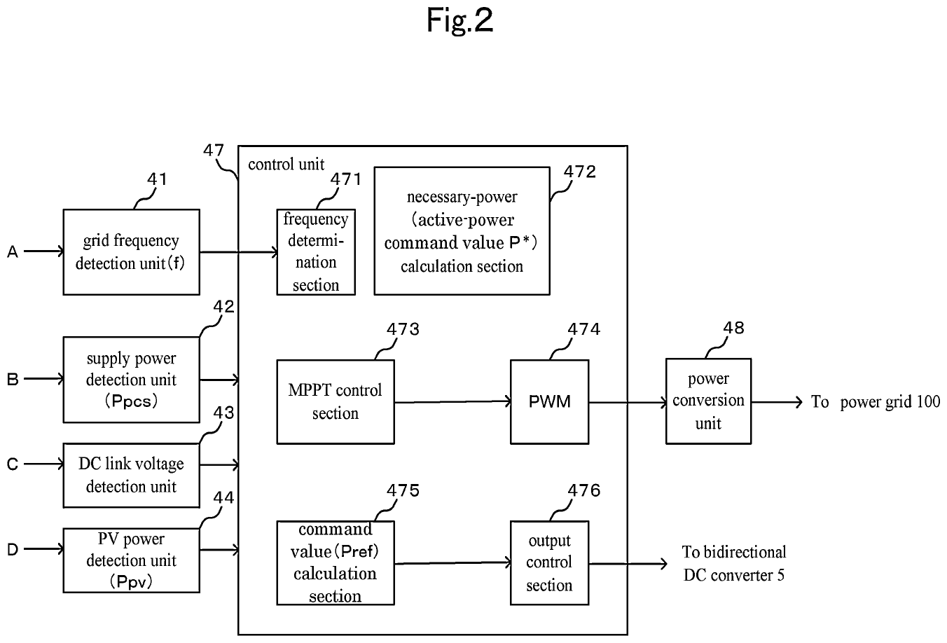

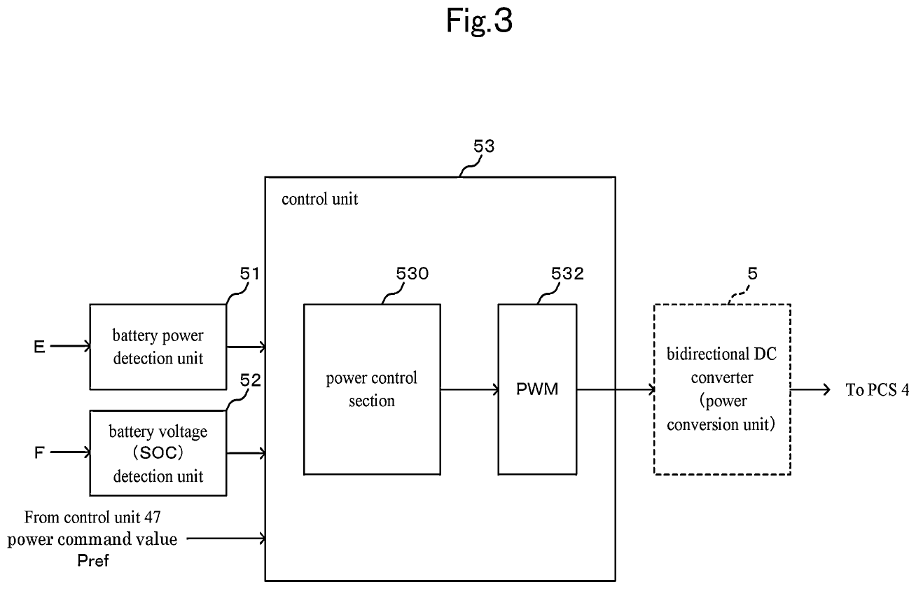

As illustrated in FIG. 1, the frequency stabilization system 1 is a grid-connected system including, for example, a photovoltaic panel 2, a storage battery 3, a PCS (power conditioner) 4, a bidirectional DC converter 5, and a diode 6. The photovoltaic panel 2 and the storage battery 3 are connected in parallel to connect to a power grid 100. In addition, the frequency stabilization system 1 is configured to include a control unit 47 (see FIG. 2) and a control unit 53 (see FIG. 3).

For example, the frequency stabilization system 1 controls power to be output to the power grid 100 by the PCS 4 in accordance with a fluctuation in the grid frequency of the power grid 100 to stabilize the grid frequency.

The photovoltaic panel 2 is capable of generating DC power from sunlight and supplying the power to the power grid 100 through the PCS 4. The storage battery 3 is chargeable with the DC power generated by the photovoltaic panel 2.

The PCS 4 has functions of converting the DC power output by at least any of the photovoltaic panel 2 and the storage battery 3 into AC power and supplying the AC power to the power grid 100. It is to be noted that the PCS 4 will be described more specifically below by using FIG. 2.

The bidirectional DC converter 5 is connected to the storage battery 3 in series. The bidirectional DC converter 5 controls the charging and discharging of the storage battery 3 for the PCS 4 based on an active-power command value Pref (described below) output by the PCS 4. For example, the bidirectional DC converter 5 constitutes an ESS (Energy Storage System: ESS) along with the storage battery 3.

The diode 6 is a protection circuit that prevents a current from flowing to the photovoltaic panel 2. Here, a configuration in which the photovoltaic panel 2 and the storage battery 3 provided in parallel are directly linked to the power grid 100 through the diode 6 as illustrated in FIG. 1 is referred to as a DC-link grid-connected system.

In addition, the frequency stabilization system 1 is provided with nodes A to F illustrated in FIG. 1. The nodes A to F allow the PCS 4 to detect parameters of the frequency stabilization system 1 such as the frequency, the power, and the voltage.

Next, functions of the PCS 4 will be described more specifically. FIG. 2 is a functional block diagram exemplifying functions of the PCS 4. As illustrated in FIG. 2, the PCS 4 includes, for example, a grid frequency detection unit 41, a supply power detection unit 42, a DC link voltage detection unit 43, a PV power detection unit 44, the control unit 47, and a power conversion unit 48.

The grid frequency detection unit 41 detects, at the node A, a grid frequency f of AC power to be output to the power grid 100 by the PCS 4 (see FIG. 1) and outputs the grid frequency f to the control unit 47. The node A serves as a connection point of the PCS 4 to the power grid 100. More specifically, the grid frequency detection unit 41 detects the grid frequency of AC power to be output to the power grid 100 by the power conversion unit 48 described below and outputs the grid frequency to a frequency determination section 471 described below.

The supply power detection unit 42 detects, at the node B, power P (or a power command value P*) supplied to the power grid 100 by the PCS 4 and outputs the power P (or the power command value P*) to the control unit 47.

The DC link voltage detection unit 43 detects, at the node C, a voltage (DC link voltage) applied to the PCS 4 from at least any of the photovoltaic panel 2 and the storage battery 3 and outputs the voltage (DC link voltage) to the control unit 47.

The PV power detection unit 44 detects, at the node D, power (PV power: Ppv) output by the photovoltaic panel 2 and outputs the power (PV power: Ppv) to the control unit 47.

The control unit 47 includes the frequency determination section 471, a necessary-power calculation section 472, an MPPT control section 473, a PWM 474, a command value calculation section 475, and an output control section 476. The control unit 47 is capable of implementing a dfdP function (Frequency-Watt function) for the power grid 100.

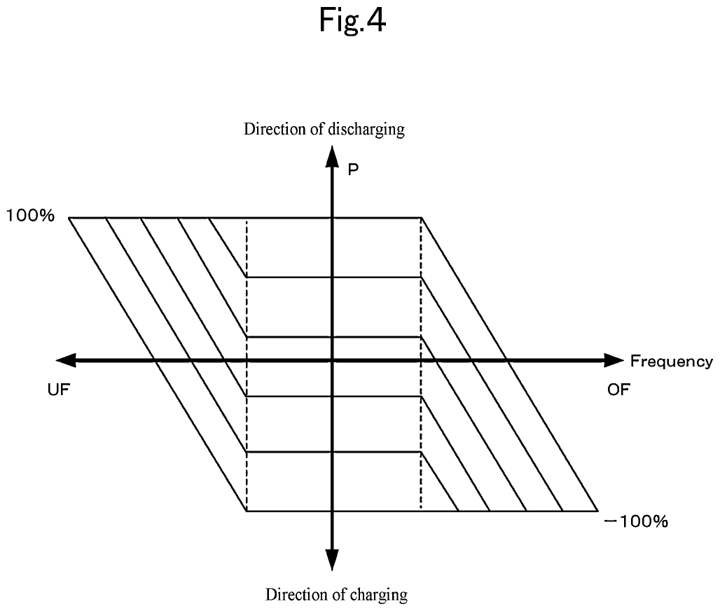

For example, as illustrated in FIG. 4, the dfdP function is a function of keeping the charging and discharging of the storage battery at a constant level in a case where the frequency of output power is within a predetermined frequency range, controlling the storage battery in a charging direction in a case where the frequency of output power is higher than the predetermined frequency range, and controlling the storage battery in a discharging direction in a case where the frequency of output power is lower than the predetermined frequency range.

The frequency determination section 471 determines whether the grid frequency f detected by the grid frequency detection unit 41 is a frequency higher than the predetermined frequency range or a frequency lower than the frequency range, or is within the frequency range. Here, the predetermined frequency range is the range of the grid frequency f defined in advance on the assumption that the frequency stabilization system 1 is in normal operation. Examples of the predetermined frequency range include a range of the rated frequency ±0.2 Hz and the like.

The necessary-power calculation section 472 obtains the grid frequency f detected by the grid frequency detection unit 41 and calculates the power P (power that supports the power grid 100: corresponding to a power command P*) necessary for the power grid 100 based on the grid frequency f.

The MPPT control section 473 performs MPPT (Maximum Power Point Tracking) to control the power conversion unit 48 through the PWM 474.

The command value calculation section 475 calculates an active-power command value (Pref) for the bidirectional DC converter 5 based on the grid frequency f or the necessary power calculated by the necessary-power calculation section 472.

For example, in a case where the frequency determination section 471 determines that the grid frequency f detected by the grid frequency detection unit 41 is a frequency higher than the frequency range described above, the command value calculation section 475 calculates an active-power command value (Pref) to bring power to be output by the photovoltaic panel 2 closer to 0 (zero) and cause the bidirectional DC converter 5 to charge the storage battery 3 with as great power as the necessary power P (corresponding to the power command P*) calculated by the necessary-power calculation section 472.

In addition, in a case where the frequency determination section 471 determines that the grid frequency f detected by the grid frequency detection unit 41 is a frequency lower than the frequency range described above, the command value calculation section 475 calculates an active-power command value (Pref) to bring power to be output by the photovoltaic panel 2 closer to the necessary power P (corresponding to the power command P*) calculated by the necessary-power calculation section 472 and cause the storage battery 3 to discharge, to the power conversion unit 48, power enough to reach the necessary power P calculated by the necessary-power calculation section 472.

In addition, in a case where the frequency determination section 471 determines that the grid frequency f detected by the grid frequency detection unit 41 is within the frequency range described above, the command value calculation section 475 calculates an active-power command value (Pref) to maximize power to be output by the photovoltaic panel 2 (to bring the power to be output by the photovoltaic panel 2 closer to the necessary power P (corresponding to the power command P*)).

The output control section 476 outputs the active-power command value (Pref) calculated by the command value calculation section 475 to the bidirectional DC converter 5. The output control section 476 then controls the charging or discharging output of the storage battery 3 to the power conversion unit 48 by the bidirectional DC converter 5 based on the active-power command value (Pref) calculated by the command value calculation section 475.

The power conversion unit 48 converts the DC power output by at least any of the photovoltaic panel 2 and the storage battery 3 into AC power and outputs the AC power to the power grid 100.

Next, functions of the bidirectional DC converter 5 will be described more specifically. FIG. 3 is a functional block diagram exemplifying functions of the bidirectional DC converter 5. As illustrated in FIG. 3, the bidirectional DC converter 5 includes a battery power detection unit 51, a battery voltage detection unit 52, and the control unit 53. The bidirectional DC converter 5 controls a power conversion unit (not illustrated) included in the bidirectional DC converter 5.

The battery power detection unit 51 detects, at the node E, power (battery power Pbatt) supplied from the bidirectional DC converter 5 to the PCS 4.

The battery voltage detection unit 52 detects, at the node F, an output voltage (Vbatt) of the storage battery 3. The battery voltage detection unit 52 may be configured to detect the charging rate (SOC: States Of Charge) of the storage battery 3.

The control unit 53 includes a power control section 530 and a PWM 532 and controls the bidirectional DC converter 5.

Next, an operation example of the frequency stabilization system 1 will be described. In a case where the grid frequency f detected by the grid frequency detection unit 41 is within the frequency range described above, the photovoltaic panel 2 discharges power to the power grid 100 and the PCS 4 controls the bidirectional DC converter 5 to cause the charging rate (SOC) of the storage battery 3 to fall within a predetermined range in the frequency stabilization system 1 (see FIG. 1).

For example, in a case where the battery voltage detection unit 52 detects the SOC, the command value calculation section 475 of the PCS 4 calculates the active-power command value Pref to cause the SOC to have a value within a predetermined range (e.g., within a range of 20% to 80% of the SOC).

The command value calculation section 475 of the PCS 4 may calculate the active-power command value Pref, for example, to cause the battery voltage Vbatt detected by the battery voltage detection unit 52 to have a value within a predetermined range (Vbatt=Vmin to Vmax) or cause the battery power Pbatt detected by the battery power detection unit 51 to have a value within a predetermined range.

In addition, in a case where the grid frequency f detected by the grid frequency detection unit 41 is within the frequency range described above, the PCS 4 gives top priority to the discharging (power selling) to the power grid 100 and controls the DC link voltage (MPPT control: Maximum Power Point Tracking control) to maximize the output power Ppv of the photovoltaic panel 2.

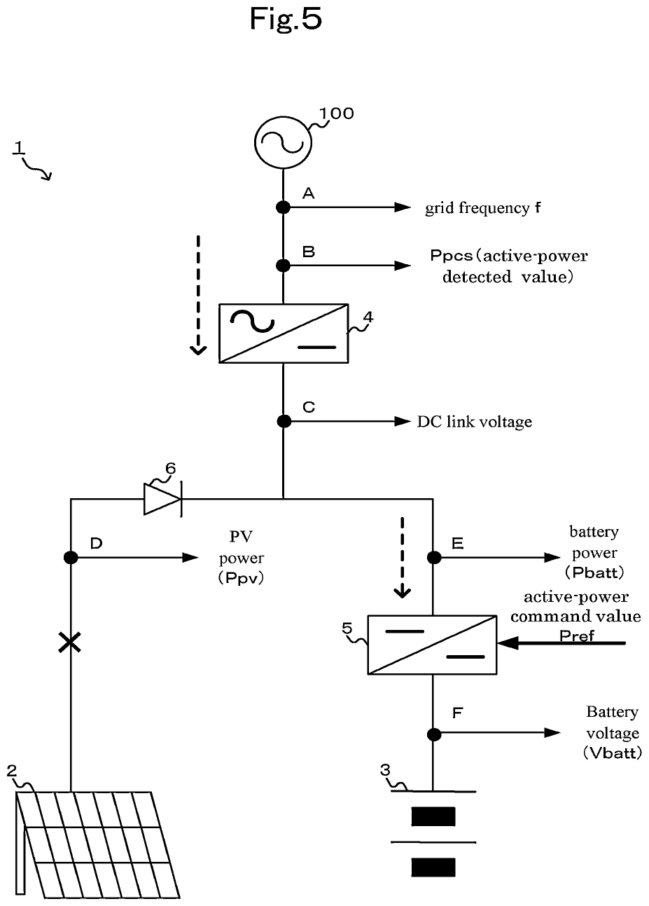

In addition, in a case where the frequency determination section 471 determines that the grid frequency f detected by the grid frequency detection unit 41 is a frequency higher than the frequency range described above, the PCS 4 performs control in the frequency stabilization system 1 as illustrated in FIG. 5. In other words, the PCS 4 performs control to prevent the photovoltaic panel 2 and the storage battery 3 from discharging power to the power grid 100.

More specifically, the necessary-power calculation section 472 calculates the power (P* necessary to support the power grid 100) necessary for the power grid 100 in accordance with the grid frequency f detected by the grid frequency detection unit 41.

The PCS 4 then controls output power for the power grid 100 with the dfdP function by using P* based on the grid frequency f detected by the frequency determination section 471.

At this time, the PCS 4 controls the DC link voltage to cause the output power Ppv of the photovoltaic panel 2 to be 0 (zero). For example, the PCS 4 performs control to achieve Pref=−P* with the active-power command value Pref for the bidirectional DC converter 5 used as a charging command value and cause the storage battery 3 to be charged.

In other words, in a case where the grid frequency f is a frequency higher than the frequency range described above, the frequency stabilization system 1 performs control to bring output power of the photovoltaic panel 2 closer to zero and charges the storage battery 3 with Pref=−P* calculated in accordance with the grid frequency f.

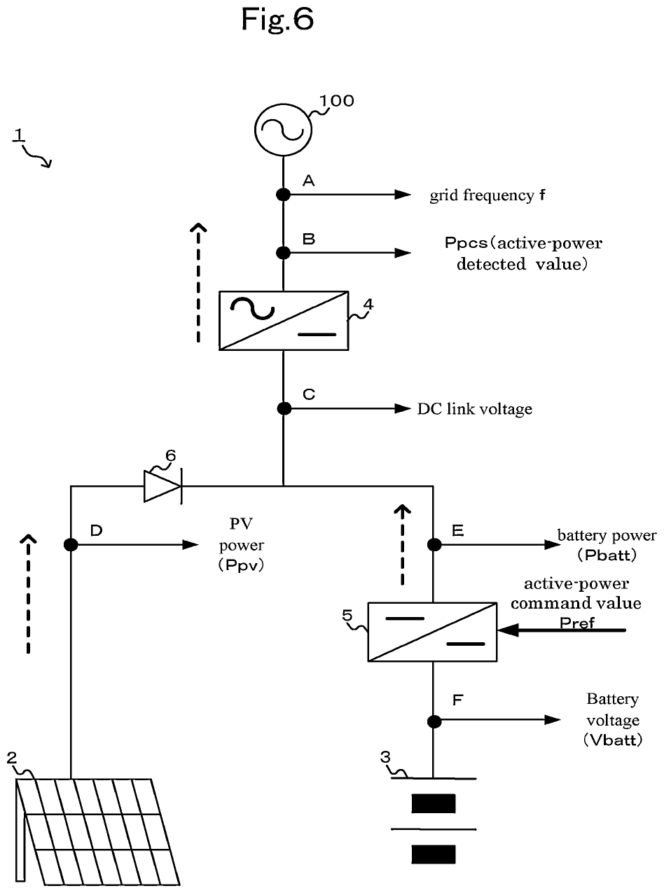

In addition, in a case where the frequency determination section 471 determines that the grid frequency f detected by the grid frequency detection unit 41 is a frequency lower than the frequency range described above, the PCS 4 performs control in the frequency stabilization system 1 as illustrated in FIG. 6. In other words, the PCS 4 performs control to cause the photovoltaic panel 2, or the photovoltaic panel 2 and the storage battery 3 to output the power necessary for the power grid 100.

More specifically, the necessary-power calculation section 472 calculates the power (P* necessary to support the power grid 100) necessary for the power grid 100 in accordance with the grid frequency f detected by the grid frequency detection unit 41.

The PCS 4 then controls output power for the power grid 100 with the dfdP function by using P* based on the grid frequency f detected by the frequency determination section 471. At this time, the PCS 4 controls the DC link voltage to cause the output power Ppv of the photovoltaic panel 2 to correspond to P*. For example, the PCS 4 performs control to achieve Pref=abs(P*−Ppv) with the active-power command value Pref for the bidirectional DC converter 5 used as a discharging command value and cause the storage battery 3 to be discharged.

In other words, in a case where the grid frequency f is a frequency lower than the frequency range described above, the frequency stabilization system 1 outputs the power for the power grid 100 with P* calculated in accordance with the grid frequency f. At this time, the PCS 4 performs control to cause the photovoltaic panel 2 to output all the power corresponding to P* as much as possible. However, if the output power Ppv of the photovoltaic panel 2 alone is insufficient for the necessary power, the PCS 4 performs control to discharge the storage battery 3 to compensate for the shortfall.

In this way, the frequency stabilization system 1 detects the grid frequency f of AC power to be output to the power grid 100 and calculates necessary power based on the detected grid frequency f and an active-power command value (Pref) for the bidirectional DC converter 5 that is based on the necessary power. The frequency stabilization system 1 thus makes it possible to convert the DC power generated by the photovoltaic panel 2 into AC power that is stabilized within the predetermined frequency range.

It is to be noted that part or the whole of each of the respective functions of the PCS 4 and the bidirectional DC converter 5 may be configured by using hardware such as a PLD (Programmable Logic Device) or an FPGA (Field Programmable Gate Array) or configured as a program to be executed by a processor such as a CPU.

### REFERENCE SIGNS LIST

1 frequency stabilization system
2 photovoltaic panel
3 storage battery
4 PCS
5 bidirectional DC converter
6 diode
41 grid frequency detection unit
42 supply power detection unit
43 DC link voltage detection unit
44 PV power detection unit
47 control unit
48 power conversion unit
51 battery power detection unit
52 battery voltage detection unit
53 control unit
100 power grid
471 frequency determination section
472 necessary-power calculation section
473 MPPT control section
474 PWM
475 command value calculation section
476 output control section
530 power control section
532 PWM

1. A frequency stabilization system including a photovoltaic panel and a storage battery that are connected in parallel to connect to a power grid, the frequency stabilization system comprising:
a power conversion unit configured to convert DC power into AC power and output the AC power to the power grid, the DC power being output by at least any of the photovoltaic panel and the storage battery;
a bidirectional DC converter that is connected to the storage battery in series, the bidirectional DC converter being configured to control charging and discharging of the storage battery for the power conversion unit based on an active-power command value;
a grid frequency detection unit configured to detect a grid frequency of AC power to be output to the power grid by the power conversion unit;
a necessary-power calculation section configured to calculate power necessary for the power grid based on the grid frequency detected by the grid frequency detection unit;
a command value calculation section configured to calculate an active-power command value for the bidirectional DC converter based on the necessary power calculated by the necessary-power calculation section; and
an output control section configured to control a charging or discharging output of the storage battery to the power conversion unit by the bidirectional DC converter based on the active-power command value calculated by the command value calculation section.

2. The frequency stabilization system according to claim 1, further comprising a frequency determination section configured to determine whether the grid frequency detected by the grid frequency detection unit is a frequency higher than a predetermined frequency range or a frequency lower than the frequency range, or is within the frequency range, wherein
the command value calculation section calculates an active-power command value to bring power to be output to the power conversion unit by the photovoltaic panel closer to 0 and cause the bidirectional DC converter to charge and discharge the storage battery with as great power as the necessary power calculated by the necessary-power calculation section in a case where the frequency determination section determines that the grid frequency detected by the grid frequency detection unit is the frequency higher than the frequency range.

3. The frequency stabilization system according to claim 2, wherein the command value calculation section calculates an active-power command value to bring the power to be output to the power conversion unit by the photovoltaic panel closer to the necessary power calculated by the necessary-power calculation section and cause the storage battery to discharge, to the power conversion unit, power enough to reach the necessary power calculated by the necessary-power calculation section in a case where the frequency determination section determines that the grid frequency detected by the grid frequency detection unit is the frequency lower than the frequency range.

4. The frequency stabilization system according to claim 2 or 3, wherein the command value calculation section calculates an active-power command value to maximize the power to be output to the power conversion unit by the photovoltaic panel in a case where the frequency determination section determines that the grid frequency detected by the grid frequency detection unit is within the frequency range.

5. A frequency stabilization method that controls a frequency stabilization system including a photovoltaic panel, a storage battery, a power conversion unit, and a bidirectional DC converter, the photovoltaic panel and the storage battery being connected in parallel to connect to a power grid, the power conversion unit being configured to convert DC power into AC power and output the AC power to the power grid, the DC power being output by at least any of the photovoltaic panel and the storage battery, the bidirectional DC converter being connected to the storage battery in series, the bidirectional DC converter being configured to control charging and discharging of the storage battery for the power conversion unit based on an active-power command value, the frequency stabilization method comprising:
a grid frequency detection step of detecting a grid frequency of AC power to be output to the power grid by the power conversion unit;
a necessary-power calculation step of calculating power necessary for the power grid based on the grid frequency detected in the grid frequency detection step;
a command value calculation step of calculating an active-power command value for the bidirectional DC converter based on the necessary power calculated in the necessary-power calculation step; and
an output control step of controlling a charging or discharging output of the storage battery to the power conversion unit by the bidirectional DC converter based on the active-power command value calculated in the command value calculation step.

6. The frequency stabilization method according to claim 5, further comprising a frequency determination step of determining whether the grid frequency detected in the grid frequency detection step is a frequency higher than a predetermined frequency range or a frequency lower than the frequency range, or is within the frequency range, wherein
an active-power command value is calculated in the command value calculation step to bring power to be output to the power conversion unit by the photovoltaic panel closer to 0 and cause the bidirectional DC converter to charge and discharge the storage battery with as great power as the necessary power calculated in the necessary-power calculation step in a case where it is determined in the frequency determination step that the grid frequency detected in the grid frequency detection step is the frequency higher than the frequency range.

7. The frequency stabilization method according to claim 6, wherein an active-power command value is calculated in the command value calculation step to bring the power to be output to the power conversion unit by the photovoltaic panel closer to the necessary power calculated in the necessary-power calculation step and cause the storage battery to discharge, to the power conversion unit, power enough to reach the necessary power calculated in the necessary-power calculation step in a case where it is determined in the frequency determination step that the grid frequency detected in the grid frequency detection step is the frequency lower than the frequency range.

8. The frequency stabilization method according to claim 6 or 7, wherein an active-power command value is calculated in the command value calculation step to maximize the power to be output to the power conversion unit by the photovoltaic panel in a case where it is determined in the frequency determination step that the grid frequency detected in the grid frequency detection step is within the frequency range.
